(19) United States
(12) Patent Application Publication
(10) Pub. No.: US 2026/0307790 A1
(43) Pub. Date: Oct. 8, 2026

(54) MIDAIR ITEM DISPENSER SYSTEMS AND METHODS

(71) Applicant: Roy L. Fox, JR., Yuma, AZ (US)

(72) Inventor: Roy L. Fox, JR., Yuma, AZ (US)

(21) Appl. No.: 19/568,174

(22) Filed: Mar. 16, 2026

Related U.S. Application Data
(60) Provisional application No. 63/773,189, filed on Mar. 17, 2025.

(51) Int. Cl. B64D 1/06; B64D 5/00; B64U 70/20; F42B 10/14

(52) U.S. Cl. CPC B64D 1/06; B64D 5/00; B64U 70/20; F42B 10/14

(57) ABSTRACT

A midair dispenser can include a releasable fastener disposed at least partially within a housing and a releasable item. The releasable item is disposed such that the releasable item is released from the housing upon the release of the releasable fastener. A jettisonable support tray can be disposed between the releasable item and the releasable fastener. A midair dispenser can comprise a number of housings, each housing having its own respective releasable fastener and releasable item. A single housing can comprise a number of releasable fasteners and releasable items.

### CROSS-REFERENCE TO RELATED APPLICATIONS

This application claims priority to and the benefit of U.S. Provisional Patent Application Ser. No. 63/773,189 filed Mar. 17, 2025, entitled “MIDAIR ITEM DISPENSER SYSTEMS AND METHODS.” The foregoing application is hereby incorporated by reference in its entirety for all purposes, including but not limited to those portions that specifically appear hereinafter, but except for any subject matter disclaimers or disavowals, and except to the extent that the incorporated material is inconsistent with the express disclosure herein, in which case the language in this disclosure shall control.

### TECHNICAL FIELD

The present disclosure relates to midair release systems, and particularly to apparatus, systems, and methods for midair releasing of items.

### BACKGROUND

When a flying device begins flight from a low altitude, its flight range can be diminished because it must expend energy while climbing to a cruising altitude. Additionally, the range will be diminished because the device must work against gravity in the process of reaching its target destination. If the device is an unpowered gliding device, it cannot begin flight from the ground. Conventionally, flying devices such as drones begin their flight missions from the ground, thus limiting their range and/or payload capacity. Accordingly, improved systems and methods for midair item release are desirable.

### SUMMARY

In general, one aspect of the subject matter described in this disclosure may be embodied in a midair dispenser. The midair dispenser can include a housing, a releasable fastener disposed at least partially within the housing, and a releasable item disposed such that the releasable item is released from the housing when the releasable fastener is released.

These and other embodiments may optionally include one or more of the following features. The midair dispenser can further include a jettisonable support tray disposed between the releasable item and the releasable fastener. The releasable item can be a drone. The releasable item can be a munition. The munition can be a kinetic munition with a plurality of retractable fins. The releasable fastener can be disposed at least partially within the munition prior to the releasable fastener being released. The releasable fastener can be an electromagnet. Releasing the releasable fastener can be triggered by a specified air pressure. Releasing the releasable fastener can be triggered by a timer. Releasing the releasable fastener can be triggered by a motor. The releasable item can be configured to provide a signal indicating it is ready for deployment. Releasing the releasable fastener can be triggered by the signal. The midair dispenser can include at least 10 releasable items.

In another aspect, the subject matter may be embodied in a midair dispenser including a housing, a first releasable fastener disposed at least partially within the housing, a second releasable fastener disposed at least partially within the housing, the first releasable fastener disposed between the second releasable fastener and an opening of the housing, and a motor mounted to the housing, the motor configured to sequentially release the first releasable fastener and the second releasable fastener to release a first releasable item and a second releasable item from the midair dispenser.

These and other embodiments may optionally include one or more of the following features. At least one of the first releasable item and the second releasable item can be a drone. At least one of the first releasable item and the second releasable item can be a munition. The first releasable fastener and the second releasable fastener can be mechanically coupled such that upon the release of the first releasable fastener the second releasable fastener is released without further intervention. The release of the second releasable fastener can be configured to occur following a programmable time delay after release of the first releasable fastener.

In another aspect, the subject matter may be embodied in a method of releasing an item midair. The method can include: lofting a midair dispenser into the air, wherein the midair dispenser comprises a plurality of tubular housings; suspending, by at least one of a kite, a parachute, a helicopter, or a balloon, the midair dispenser in the air; releasing, by a motor, a releasable fastener disposed at least partially within the midair dispenser; and releasing, by the releasable fastener, a releasable item from the midair dispenser into the air.

The lofting the midair dispenser into the air can comprise carrying, by an aircraft, the midair dispenser into air. The method can further comprise deploying the midair dispenser from the aircraft. The aircraft may comprise at least one of an airplane, a helicopter, a quadcopter, or a cruise missile.

In another aspect, the subject matter may be embodied in a method of using a midair dispenser. The method can include supporting, by a releasable fastener, a releasable item within the midair dispenser, and activating the releasable fastener to cause the releasable item to separate from the midair dispenser under the influence of gravity.

In another aspect, the subject matter may be embodied in a midair dispenser including a plurality of housings, each housing including a first releasable fastener disposed at least partially within the housing, and a first releasable item disposed such that the first releasable item is released from the housing upon a release of the first releasable fastener.

These and other embodiments may optionally include one or more of the following features. The midair dispenser can further include a second releasable fastener disposed at least partially within the housing, the first releasable fastener being disposed between the second releasable fastener and an opening of the housing.

The contents of this summary section are provided only as a simplified introduction to the disclosure and are not intended to be used to limit the scope of the appended claims.

### BRIEF DESCRIPTION OF THE DRAWINGS

With reference to the following description, appended claims, and accompanying drawings:

FIG. 1 illustrates a midair dispenser suspended from a helicopter, in accordance with an embodiment of the present disclosure.

FIG. 2 illustrates a midair dispenser suspended from a balloon, in accordance with an embodiment of the present disclosure.

FIG. 3 illustrates a midair dispenser suspended from a parachute assembly, in accordance with an embodiment of the present disclosure.

FIG. 4 illustrates a schematic view of a midair dispenser containing a releasable item, in accordance with an embodiment of the present disclosure.

FIG. 5 illustrates a schematic view of a midair dispenser containing a releasable item interfacing with a jettisonable support tray, in accordance with an embodiment of the present disclosure.

FIG. 6 illustrates a schematic view of a midair dispenser having a motor, a plurality of releasable fasteners, a plurality of releasable items, and a plurality of jettisonable support trays, in accordance with an embodiment of the present disclosure.

FIG. 7 illustrates a schematic side view of a releasable fastener, in accordance with an embodiment of the present disclosure.

FIG. 8 illustrates a schematic side view of a second releasable fastener, in accordance with an embodiment of the present disclosure.

FIG. 9 illustrates a schematic top view of a third releasable fastener, in accordance with an embodiment of the present disclosure.

FIG. 10A illustrates a schematic side view of a fourth releasable fastener, in accordance with an embodiment of the present disclosure.

FIG. 10B illustrates a schematic top view of a fourth releasable fastener, in accordance with an embodiment of the present disclosure.

FIG. 11A illustrates a schematic side view of a plurality of a fourth releasable fastener, in accordance with an embodiment of the present disclosure.

FIG. 11B illustrates a schematic top view of a plurality of a fourth releasable fastener, in accordance with an embodiment of the present disclosure.

FIG. 12A illustrates a schematic side view of a fifth releasable fastener, in accordance with an embodiment of the present disclosure.

FIG. 12B illustrates a schematic top view of a fifth releasable fastener, in accordance with an embodiment of the present disclosure.

FIG. 13A illustrates a schematic side view of a plurality of a fifth releasable fastener, in accordance with an embodiment of the present disclosure.

FIG. 13B illustrates a schematic top view of a plurality of a fifth releasable fastener, in accordance with an embodiment of the present disclosure.

FIG. 14 illustrates a schematic side view of a sixth releasable fastener, in accordance with an embodiment of the present disclosure.

FIG. 15 illustrates a schematic top view of a sixth releasable fastener, in accordance with an embodiment of the present disclosure.

FIG. 16 illustrates a schematic bottom view of a plurality of housings, in accordance with an embodiment of the present disclosure.

FIG. 17 illustrates a schematic bottom view of a plurality of hexagonal housings, in accordance with an embodiment of the present disclosure.

FIG. 18 illustrates a schematic bottom view of a plurality of tubular housings, in accordance with an embodiment of the present disclosure.

FIG. 19 illustrates a perspective view of a housing, in accordance with an embodiment of the present disclosure.

FIG. 20 illustrates a perspective view of a housing, in accordance with an embodiment of the present disclosure.

FIG. 21 illustrates a cutaway side view of a housing, in accordance with an embodiment of the present disclosure.

FIG. 22 illustrates a schematic view of a midair dispenser containing a plurality of releasable items, in accordance with an embodiment of the present disclosure.

FIG. 23 illustrates a schematic view of a midair dispenser containing a plurality of releasable items, in accordance with an embodiment of the present disclosure.

FIG. 24 illustrates a method for releasing an item midair, in accordance with various embodiments.

FIG. 25 illustrates a method for using a midair dispenser, in accordance with various embodiments.

FIG. 26 illustrates a perspective view of a hyperbolic paraboloid shaped support tray, in accordance with an embodiment of the present disclosure.

FIG. 27 illustrates a perspective view of a hyperbolic paraboloid shaped support tray within a housing, in accordance with an embodiment of the present disclosure.

FIG. 28 illustrates a perspective of a partial hyperbolic paraboloid shaped support tray within a housing, in accordance with an embodiment of the present disclosure.

FIG. 29 illustrates a perspective view of a hyperbolic paraboloid shaped support tray within a housing, in accordance with an embodiment of the present disclosure.

### DETAILED DESCRIPTION

The following description is of various exemplary embodiments only, and is not intended to limit the scope, applicability or configuration of the present disclosure in any way. Rather, the following description is intended to provide a convenient illustration for implementing various embodiments including the best mode. As will become apparent, various changes may be made in the function and arrangement of the elements described in these embodiments without departing from the scope of the appended claims.

Disclosed herein are systems, methods, and devices for implementing a midair dispenser for releasing one or more items (e.g., a drone, loitering munition, missile, and/or the like). Aspects and/or embodiments are directed to a housing with a releasable fastener apparatus for midair release of one or more releasable items. The apparatus can both secure the releasable item, or items, to or within the dispenser and, additionally, can control the timing by which the releasable item, or items, is dispensed. Moreover, the apparatus can secure and/or release multiple items of different types, shapes, sizes, weights, etc. Stated differently, the apparatus is not limited to securing and/or releasing only one type of releasable item. Moreover, the apparatus can be adapted for dispensing relatively fragile items (e.g., a helicopter type drone).

Systems, apparatus, and methods of the present disclosure can be used for a great variety of applications, such as applications in which it is desirable to deploy a number of drones or munitions to a target deployment zone from a distance. Examples of such applications can be a combat scenario where it is not practicable to deliver a number of drones or munitions by ground, deployment of drones or munitions to areas inaccessible by ground, deployment of drones or munitions over a lake or ocean, etc.

For the sake of brevity, conventional techniques for releasable fasteners and/or the like may not be described in detail herein. Furthermore, the connecting lines shown in various figures contained herein are intended to represent exemplary functional relationships and/or physical couplings between various elements. It should be noted that many alternative or additional functional relationships or physical connections may be present in a practical system for a housing with releasable fasteners and/or related methods of use.

When a flying device begins flight from a high altitude, its flight range can be greater because it does not need to consume power to climb to a cruising altitude. With a high release altitude, the range of the device will be extended because gravity will assist the device in reaching its destination. If the device is an unpowered gliding device, it is mandatory that the device be carried aloft by some outside force. Because of these and other benefits, helicopter type drones or other unmanned flying devices can be stored inside a vertically oriented housing such that they can be carried to a high altitude before being released for flight. The housing can be tubular, or can be any other suitable shape for storing and releasing unmanned flying devices. Multiple housings can be coupled together to increase the volume of unmanned flying devices that can be deployed to a target deployment zone in a single launch package.

The unmanned flying devices can be stored such that they are supported within the housing by a releasable fastener. Each unmanned flying device can correspond to one or more releasable fasteners. By doing so, the midair dispenser is enabled to perform a controlled release of the unmanned flying devices when desired conditions are reached. The unmanned flying devices can be released from the housing sequentially, controlled by a sequential release of their respective releasable fasteners. This release process can prevent the unmanned flying devices from colliding with or interfering with each other upon release from the housing or housings.

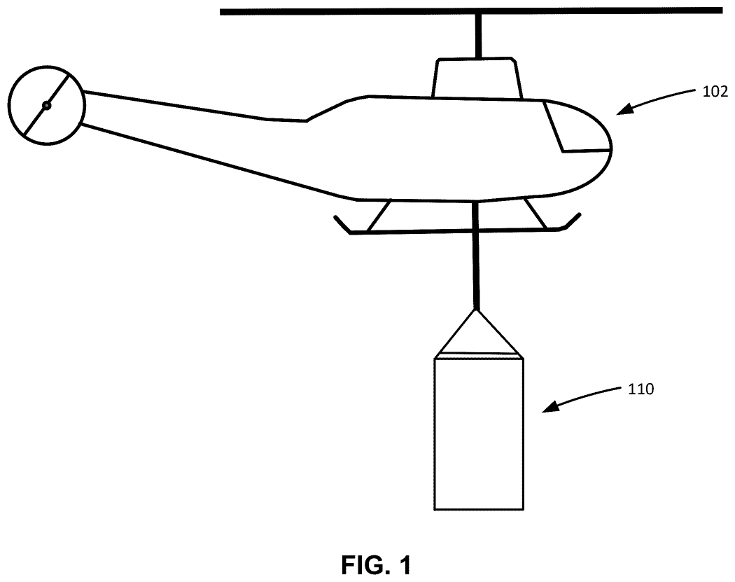

With reference to FIG. 1, in accordance with various embodiments, a midair dispenser 110 is illustrated as being suspended midair. In the illustrated embodiment, the midair dispenser 110 is suspended from a helicopter 102.

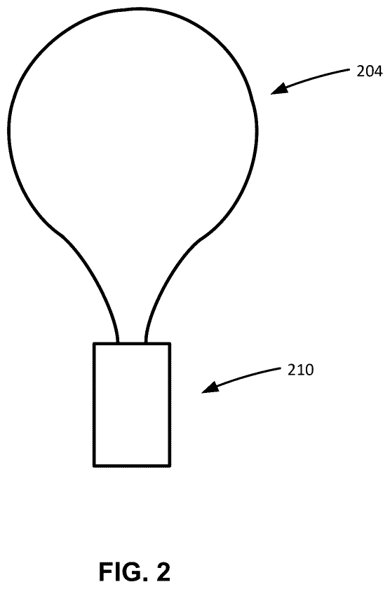

With reference to FIG. 2, in accordance with various embodiments, a midair dispenser 210 is illustrated as being suspended midair. In the illustrated embodiment, the midair dispenser 210 is suspended from a balloon 204. The balloon 204 may be configured to ascend to a chosen float-altitude and may then drift to a target zone. The configuration of balloon 204's ascent may be controlled by metering the amount of gas within balloon 204. The metering of the amount of gas within balloon 204 may be performed prior to the launch of balloon 204 or after the launch of balloon 204. Balloon 204 may be configured such that a float-altitude of balloon 204 may be altered mid-flight by the remote release of gas and/or ballast from balloon 204.

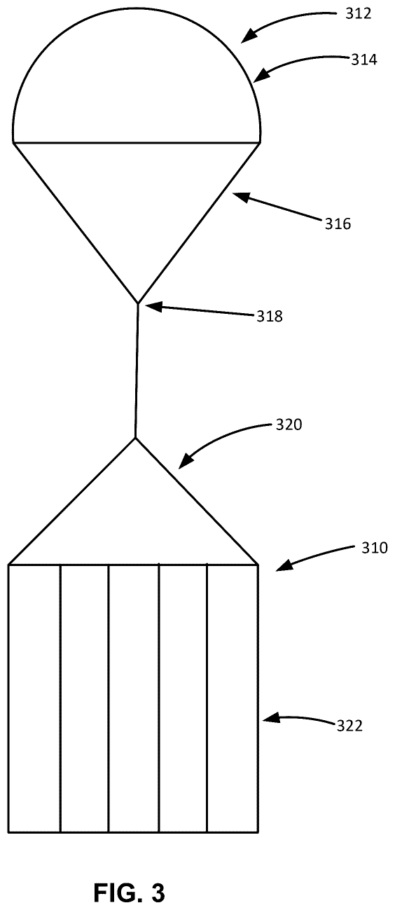

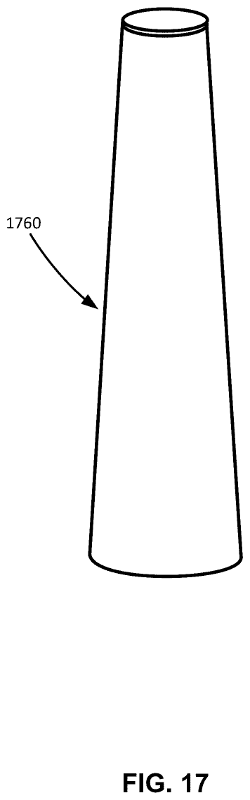

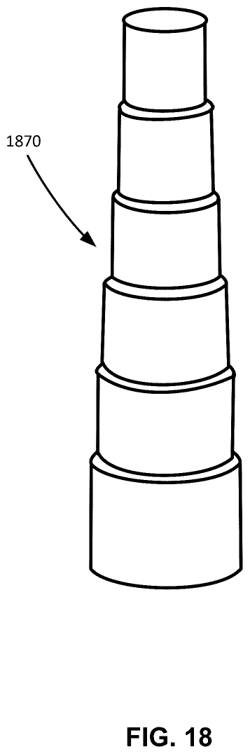

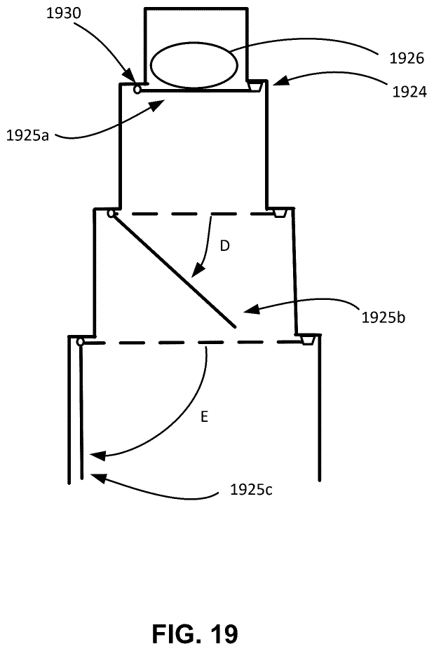

With reference to FIG. 3, in accordance with various embodiments, a midair dispenser 310 is illustrated as being suspended midair. In the illustrated embodiment, the midair dispenser 310 is shown suspended from parachute 312; however, a midair dispenser 310 can be suspended from any suitable apparatus, including a parachute, a helicopter, an airplane, a balloon, a kite, a crane, etc. The parachute 312 can include a canopy 314 and a plurality of suspension lines 316 coupled to canopy 314, for example, at the edges of canopy 314. The suspension lines 316 can be connected to canopy 314 and can descend therefrom to lower ends for attachment to a load (e.g., midair dispenser 310). A plurality of suspension lines 316 may converge (or couple to one another) at a convergence point 318. Although one convergence point 318 of suspension lines 316 is illustrated for ease of illustration, additional convergence points (e.g., two, three, four, five, six, or more) can be disposed equidistantly about the canopy 314 whereby a plurality of immediately adjacent suspension lines converge. The suspension slings 320 can be configured to secure the midair dispenser 310 to the parachute 312. The suspension slings 320 can be configured to reduce shock experienced by midair dispenser 310 and/or the parachute system itself. The suspension slings 320 may meet at a convergence point 318. The suspension slings 320 can extend between and to the midair dispenser 310 and the suspension lines 316 to suspend the midair dispenser 310 in an upright position. Midair dispenser 310 may be comprised of a plurality of housings 322. Each housing 322 can be oriented in a substantially vertical orientation, for example when disposed beneath a parachute. A housing 322 may have a constant diameter; for example, a housing 322 may have a generally cylindrical form. Alternatively, a housing 322 may have a linearly (see FIG. 17), nonlinearly, and/or stepwise (see FIGS. 18, 19) increase in diameter from top to bottom. Housings 322 in midair dispenser 310 may be similar to one another. Alternatively, housings 322 in midair dispenser 310 may differ from one another in type, size, configuration, number, and/or the like.

In various embodiments, midair dispenser 310 is configured to secure one or more items and release the item(s) while the midair dispenser is suspended above a surface midair. For example, the midair dispenser can be dropped from an aircraft over an area at or near a target deployment zone and the item(s) can be released from the midair dispenser 310.

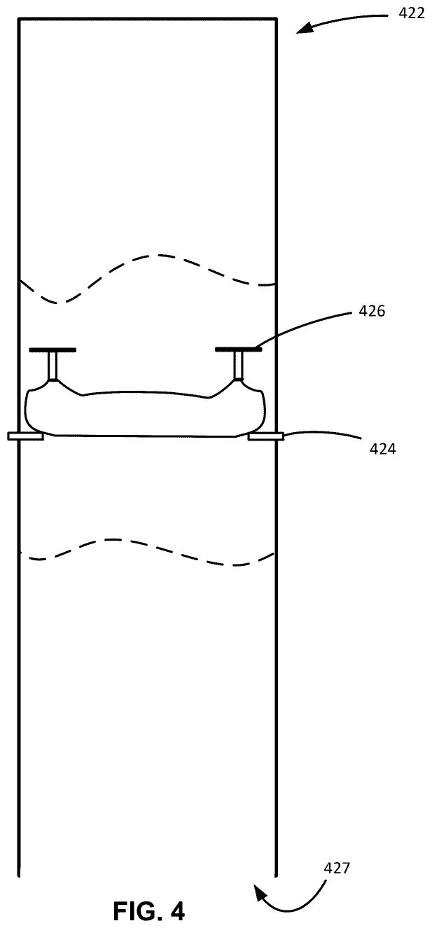

FIG. 4 is an example of a housing 422 and shows a portion of the inside of housing 422. A releasable item 426 is stowed within the housing 422. In various embodiments, the releasable item can be supported directly by the releasable fastener 424. The housing can have an opening 427 through which the releasable item 426 can exit the housing 422. In the illustrated embodiment, the opening 427 is located at a lower end of the housing 422 (i.e., the lower end of the housing is open). In various embodiments, the opening 427 can be covered by a door or panel that is removable (or opened) before dispensing releasable item(s) 426. The releasable fastener 424 can be disposed such that it is partially within the housing 422. The releasable fastener 424 can also be disposed such that it is entirely within the housing 422.

In various embodiments, releasable fastener 424 can be a mechanical fastener. Such a releasable fastener 424 can be made of iron, steel, composite materials, plastic materials, or any other suitable material for forming a releasable fastener. Releasable fastener 424 can also be a magnet, such as an electromagnet. It is contemplated that releasable fastener 424 can be any suitable apparatus for supporting a releasable item 426, directly or indirectly, and for being released in a manner such that it no longer supports releasable item 426, directly or indirectly. After the release of releasable fastener 424, releasable fastener 424 can be disposed partially within housing 422, entirely within housing 422, or entirely outside of housing 422. The release of releasable fastener 424 can be triggered by a motor. The release of releasable fastener 424 can also be triggered, for example, by a timer, by a magnetic field, by detection of specified air pressure, by receipt of a triggering signal, and/or the like. Release of releasable fastener 424 may include a positional transformation of releasable fastener 424. While herein referred to as a positional transformation of releasable fastener 424, it is contemplated that release of releasable fastener 424 may also be accomplished for example by release of an electromagnet, severance of a coupling, or any other suitable method of releasing releasable fastener 424.

In various embodiments, releasable item 426 can be a drone, such as a quad-copter drone, a tri-copter drone, a single rotor heli-drone, a fixed wing rotor drone, or any other drone or unmanned apparatus suitable for deploying at an elevated position. Releasable item 426 can also be a munition, such as a missile, a bomb, a kinetic munition, a kinetic munition with a plurality of retractable fins, a loitering munition, or any other munition apparatus suitable for deploying at an elevated position. The releasable item 426 can be configured to provide a signal (e.g., a radio signal, an infrared signal, or any other suitable type of wireless signal) indicating that the releasable item 426 is ready to be deployed. The signal may also be transmitted by physical connection, such as a wired connection. The signal can trigger the positional transformation of releasable fastener 424. The releasable item 426 can be supported within the housing 422 by the releasable fastener 424. When the releasable fastener 424 is positionally transformed it can thereby leave the releasable item 426 unsupported within housing 422. The releasable item 426 can then exit the housing 422 through opening 427 under the influence of gravity.

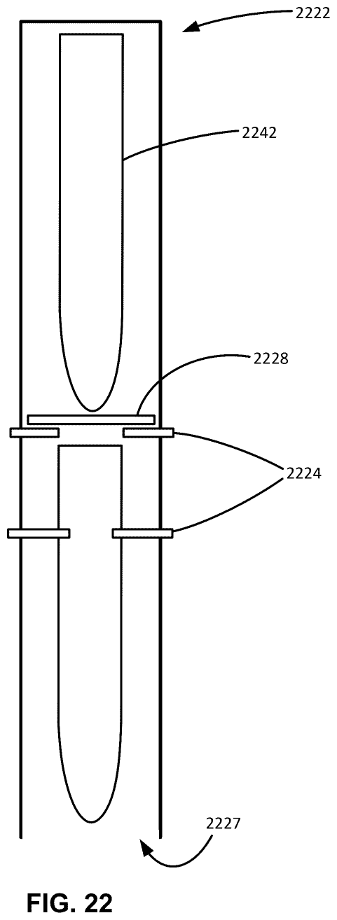

In various embodiments, a munition may not be suitable for being supported by resting on releasable fastener 424. The munition can be designed such that releasable fastener 424 extends partially within the body of the munition (see FIG. 22). For example, a recess may be created in the body of the munition, such that when the munition is stored within housing 422 the releasable fastener 424 extends into the recess, thereby supporting the munition within housing 422. When the releasable fastener 424 is released it can withdraw from the recess within the body of the munition, thereby leaving the munition unsupported within housing 422. The munition can then exit the housing 422 through opening 427 under the influence of gravity.

In various embodiments, the design of the housing 422 can be altered to facilitate methods of loading releasable item 426 into the housing 422. In the illustrated embodiment, releasable item 426 may be loaded through opening 427 located on the bottom of housing 422. Housing 422 can also be designed such that the top face of housing 422 can be opened and releasable item 426 may be loaded through the top face of housing 422. Further, housing 422 can be designed such that it is comprised of several modular sections, each section storing one or more releasable item(s) 426. Releasable item 426 can be loaded into a modular section, and a plurality of modular sections can then be coupled to form housing 422.

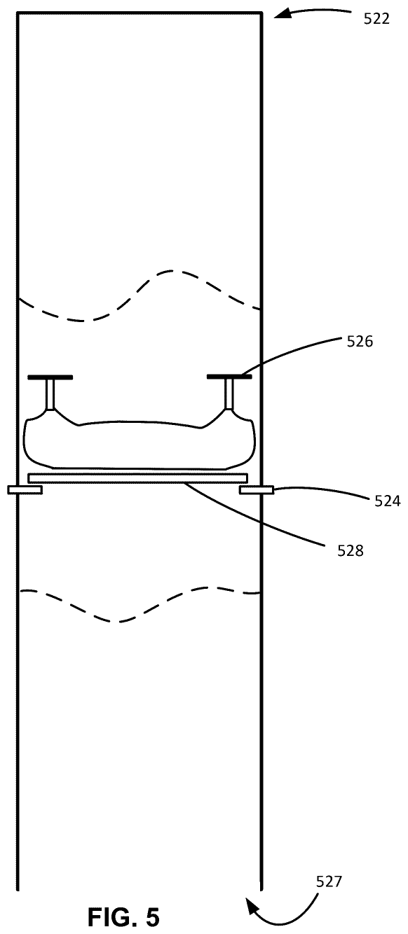

With reference to FIG. 5, it may be desirable to use a jettisonable support tray 528 in conjunction with releasable fastener 524 and releasable item 526. In various embodiments, a releasable item 526 may not be suitable for being supported by resting on releasable fastener 524. A jettisonable support tray 528 can thus be supported by releasable fastener 524, directly or indirectly, and releasable item 526 may be supported by the jettisonable support tray 528. For example, the jettisonable support tray 528 can be disposed between the releasable fastener 524 and the releasable item 526. Embodiments utilizing a jettisonable support tray 528 can allow any releasable item 526 that fits within housing 522 to be accommodated for use with midair dispenser 310 without requiring a synchronized design effort between the releasable fastener 524 and the releasable item 526. The jettisonable support tray 528 can be designed such that it is discarded and not retrieved after use in the midair dispenser 310, for example by being ejected through opening 527.

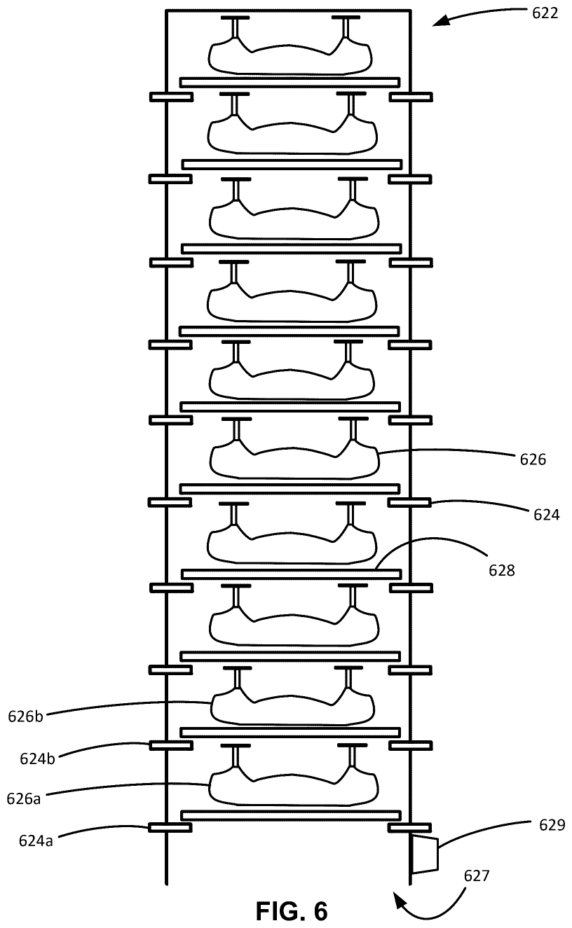

With reference to FIG. 6, a plurality of releasable fasteners 624 can be disposed vertically within or partially within housing 622. A plurality of jettisonable support trays 628 may be used, each in conjunction with one or more releasable fasteners 624. In this manner, a plurality of releasable items 626 may be supported within a housing 622, thereby significantly increasing the number of releasable items 626 that may be deployed from the midair dispenser 310 to a target deployment zone. It is contemplated that a midair dispenser 310 can thus hold at least ten releasable items 626 for deployment within a single housing 622. The number of releasable items 626 that may be deployed may depend on the size and weight of the releasable items 626 as well as the capability of the device, such as an airplane, which is used to transport the midair dispenser 310 to a launch altitude. It is not necessary for each of the plurality of releasable items 626 to be identical; rather there can be a number of different releasable items 626 within a single housing 622. For example, within a single housing 622 a first releasable item may be a drone apparatus, such as a quadcopter drone, while a second releasable item may be a munition apparatus, such as a loitering munition.

In an exemplary embodiment, a housing 622 can have a first releasable fastener 624a and a second releasable fastener 624b, each disposed at least partially within the housing 622 and configured to support, directly or indirectly, a respective releasable item 626a and 626b. A motor 629 can be coupled to the housing 622. The motor 629 can be configured to sequentially transform a first position of the first releasable fastener 624a and a second position of the second releasable fastener 624b with respect to the housing, thereby leaving releasable items 626a and 626b unsupported within the housing 622. Releasable items 626a and 626b can then sequentially exit the housing 622 through opening 627 under the influence of gravity. The sequential transformation of the first releasable fastener 624a and the second releasable fastener 624b can be accomplished by coupling each fastener to the motor 629. The sequential transformation can also be accomplished by coupling first releasable fastener 624a to second releasable fastener 624b such that positionally transforming releasable fastener 624a by the motor automatically transforms the position of releasable fastener 624b by the coupling. The coupling of first releasable fastener 624a and second releasable fastener 624b can be accomplished for example mechanically, electrically, magnetically, or by any other suitable method for coupling a plurality of releasable fasteners. The positional transformation of releasable fastener 624b can be set to occur following a programmable time delay after transformation of releasable fastener 624a.

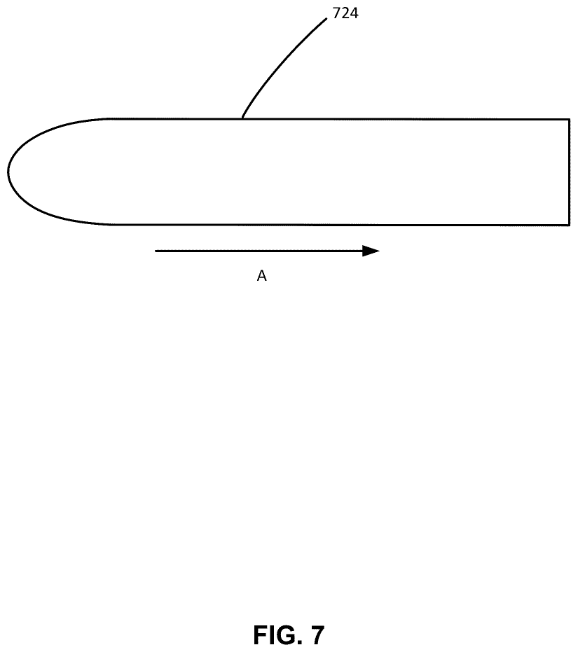

FIG. 7 is an example of a side view of one embodiment of a releasable fastener 724. In the illustrated embodiment, the releasable fastener 724 is configured to be positionally transformed on a horizontal axis (i.e., slide to the left or right or move linearly). Arrow A depicts an example of such a positional transformation.

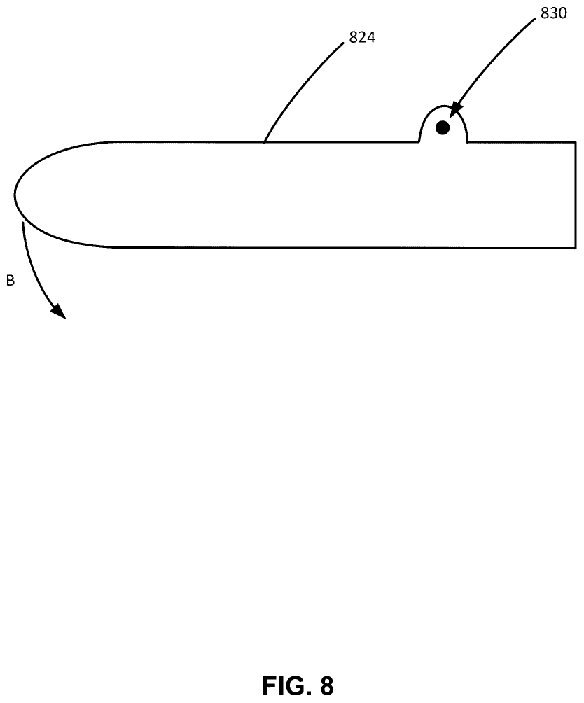

FIG. 8 is an example of a side view of an alternative embodiment of a releasable fastener 824. In the illustrated embodiment, releasable fastener 824 is configured to be positionally transformed rotationally about a hinge point 830. The rotational transformation about the hinge point can be clockwise or counterclockwise with respect to a housing (i.e., pivot downwardly). Arrow B depicts an example of such a positional transformation.

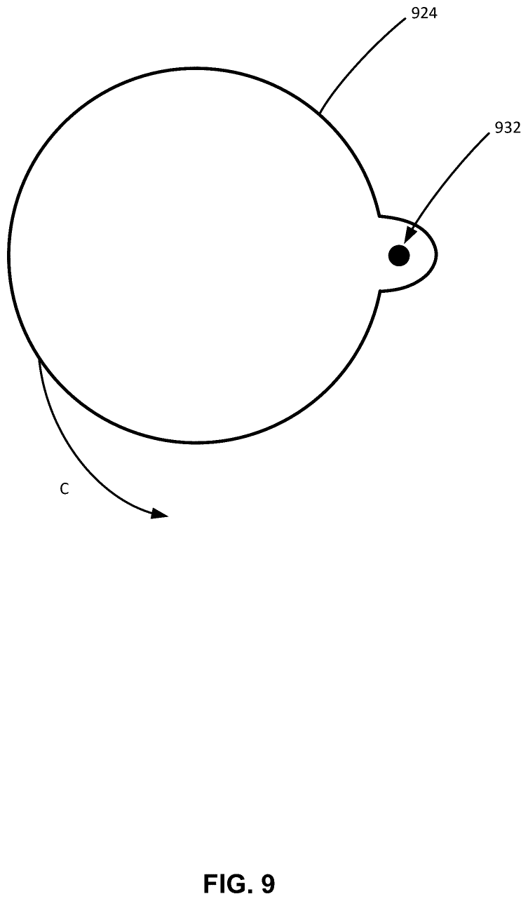

FIG. 9 is an example of a top view of an alternative embodiment of a releasable fastener 924. In the illustrated embodiment, releasable fastener 924 is configured to be positionally transformed rotationally about a rotation point 932. The rotational transformation can occur about a vertical axis that is substantially parallel to a vertical axis of a housing (i.e., rotate laterally). Arrow C depicts an example of such a positional transformation.

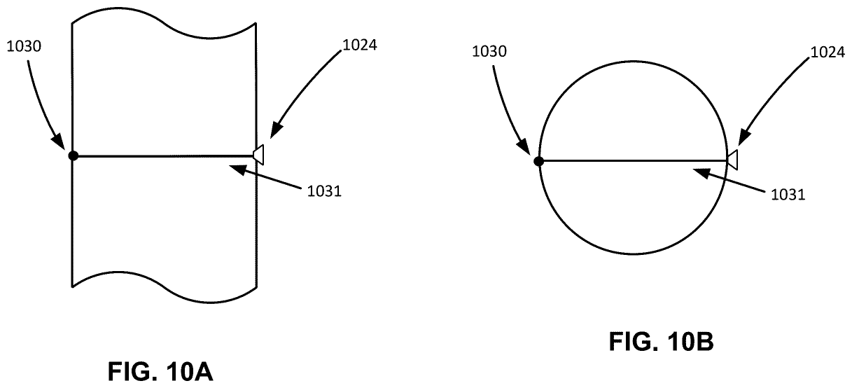

FIG. 10A is an example of a side view of an alternative embodiment of a section of a housing of midair dispenser 310. Releasable fastener 1024 may be coupled to a first end of beam 1031. A second end of beam 1031 may be coupled to hinge 1030. Upon the release of releasable fastener 1024, beam 1031 may rotate about hinge 1030. Hinge 1030 may optionally be spring loaded to enable rapid pivoting of beam 1031 and to prevent beam 1031 from rebounding into the release path of a releasable item. In this manner, a releasable item supported within the housing by beam 1031 may be released. FIG. 10B is an example of a top view of the alternative embodiment described with respect to FIG. 10A.

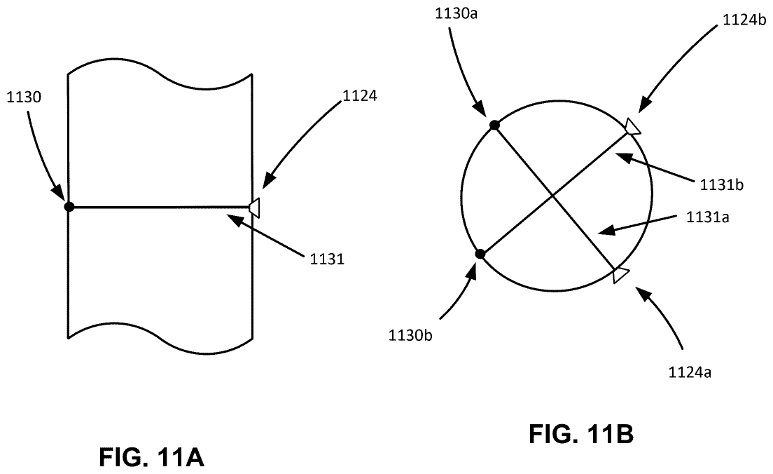

FIG. 11A is an example of a side view of an alternative embodiment of a section of a housing of midair dispenser 310. The housing can include a releasable fastener 1124, a hinge point 1130, and a beam 1131. FIG. 11B is an example of a top view of the alternative embodiment of FIG. 11A. The housing may have multiple beams 1131a and 1131b which may support a single releasable item. A first end of beam 1131a may be coupled to releasable fastener 1124a, while a first end of beam 1131b may be coupled to releasable fastener 1124b. A second end of beam 1131a may be coupled to hinge 1130a, while a second end of beam 1131b may be coupled to hinge 1130b. Upon release of releasable fasteners 1124a and 1124b, beams 1131a and 1131b may rotate about hinge 1130a and 1130b respectively. Hinges 1130a and 1130b may optionally be spring loaded to enable rapid pivoting of beams 1131a and 1131b and to prevent beams 1131a and 1131b from rebounding into the release path of a releasable item. In this manner, a releasable item supported within the housing by beams 1131a and 1131b may be released. Releasable fasteners 1124a and 1124b may be released simultaneously or may be released in sequence. While illustrated herein as having two beams, it is contemplated that any number of beams may support a single releasable item within the housing. Each of the beams may be configured such that they are coupled to a respective releasable fastener and a respective hinge as described with respect to beams 1131a and 1131b.

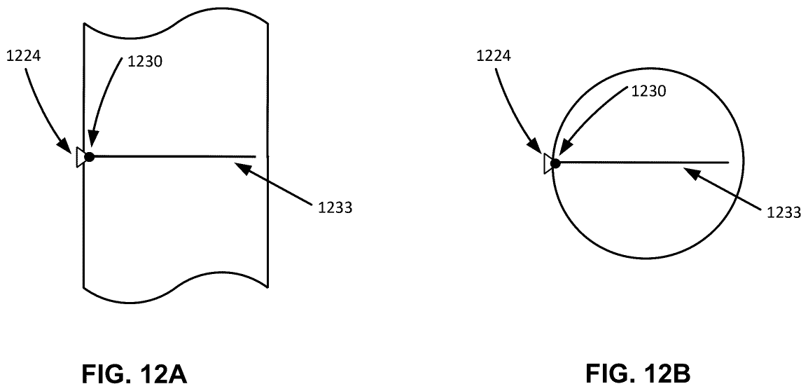

FIG. 12A is an example of a side view of an alternative embodiment of a section of a housing of midair dispenser 310. Releasable fastener 1224 may be coupled to a first end of cantilevered beam 1233. The first end of cantilevered beam 1233 may additionally be coupled to a hinge 1230. Upon the release of releasable fastener 1224, cantilevered beam 1233 may rotate about hinge 1230. Hinge 1230 may optionally be spring loaded to enable rapid pivoting of beam 1233 and to prevent beam 1233 from rebounding into the release path of a releasable item. In this manner, a releasable item supported within the housing by beam 1233 may be released. FIG. 12B is an example of a top view of the alternative embodiment described with respect to FIG. 12A.

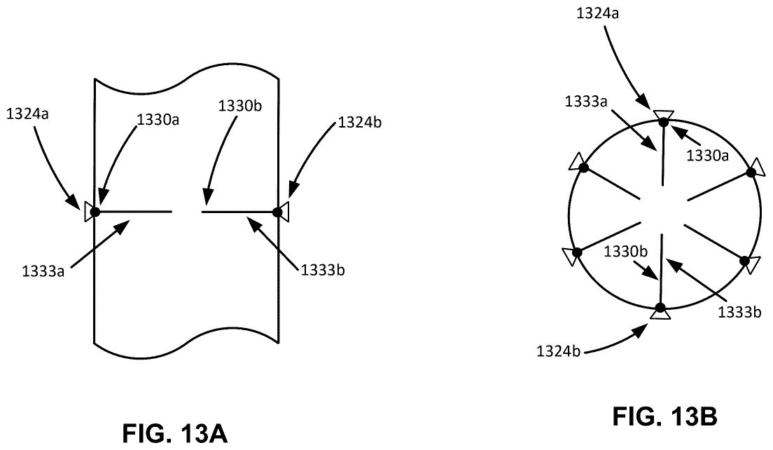

FIG. 13A is an example of a side view of an alternative embodiment of a section of a housing of midair dispenser 310. The housing may have multiple cantilevered beams 1333a and 1333b which may support a single releasable item. A first end of cantilevered beam 1333a may be coupled to releasable fastener 1324a, while a first end of cantilevered beam 1333b may be coupled to releasable fastener 1324b. The first end of cantilevered beam 1333a may additionally be coupled to hinge 1330a, while the first end of cantilevered beam 1333b may be coupled to hinge 1330b. Upon release of releasable fasteners 1324a and 1324b, cantilevered beams 1333a and 1333b may rotate about hinge 1330a and 1330b respectively. Hinges 1330a and 1330b may optionally be spring loaded to enable rapid pivoting of cantilevered beams 1333a and 1333b and to prevent cantilevered beams 1333a and 1333b from rebounding into the release path of a releasable item. In this manner, a releasable item supported within the housing by cantilevered beams 1333a and 1333b may be released. Releasable fasteners 1324a and 1324b may be released simultaneously or may be released in sequence. While discussed herein as having two cantilevered beams, it is contemplated that any number of cantilevered beams may support a single releasable item within the housing, for example, as illustrated by FIG. 13B wherein six cantilevered beams are configured to support a single releasable item. Each of the cantilevered beams may be configured such that they are coupled to a respective releasable fastener and a respective hinge as described with respect to cantilevered beams 1333a and 1333b.

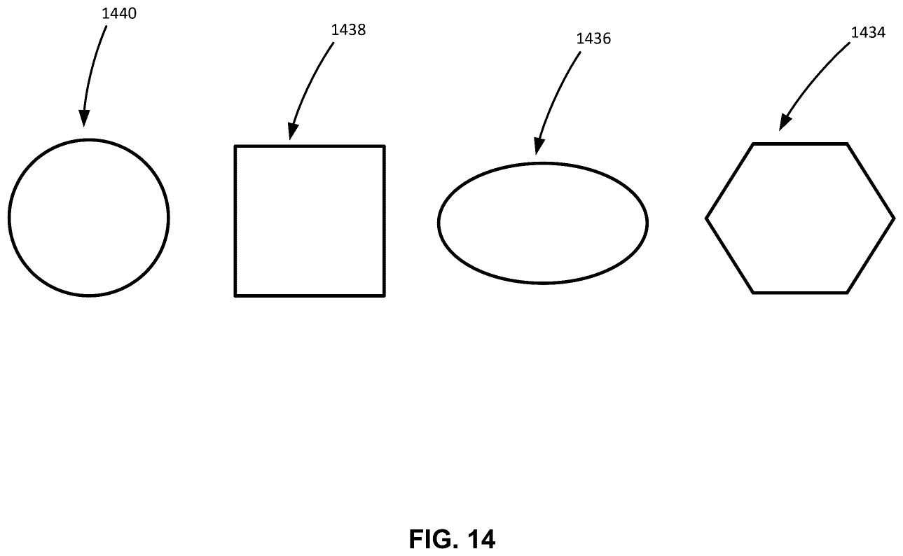

With respect to FIG. 14, several exemplary embodiments of housing 322 are provided. For example, a hexagonal housing 1434, an ovular housing 1436, a square housing 1438, and a tubular housing 1440 are provided. The housing 322 may further comprise any suitable shape which can house a releasable item 426 supported by a releasable fastener 424. Various embodiments of housing 322 may be desired depending on the design characteristics of releasable item 426. For example, if releasable item 426 has a length greater than its width, a rectangular or ovular tube may be desirable in order to maintain the desired orientation of releasable item 426 within the housing 322. In such an exemplary case, the housing 322 may also be circular, and may use internal ribs and/or fins to maintain the desired orientation of releasable item 426. In various embodiments, suitable housing 322 shapes such as square housings, rectangular housings, and/or hexagonal housings may enable the wall segments of one housing 322 to additionally function as wall segments of adjacent housings 322.

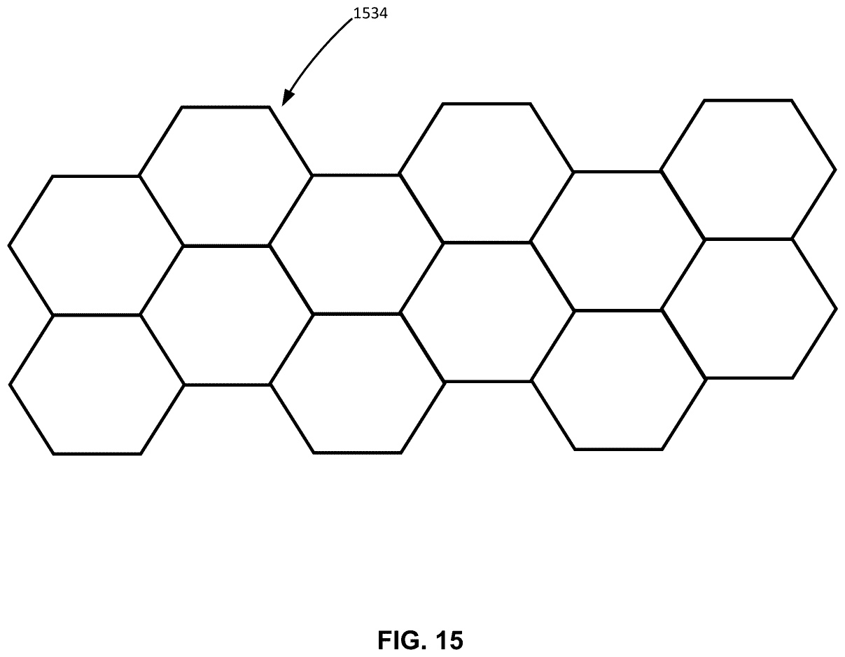

FIG. 15 provides an exemplary embodiment of a plurality of hexagonal housings 1534. In the illustrated embodiment, a plurality of hexagonal housings 1534 can be coupled. The coupled hexagonal housings 1534 can be suspended from a single parachute 312, a helicopter, or a balloon. By coupling a plurality of hexagonal housings 1534 for suspension by a single parachute 312, helicopter, or balloon, the number of releasable items 426 that can be deployed to a target deployment zone is greatly increased.

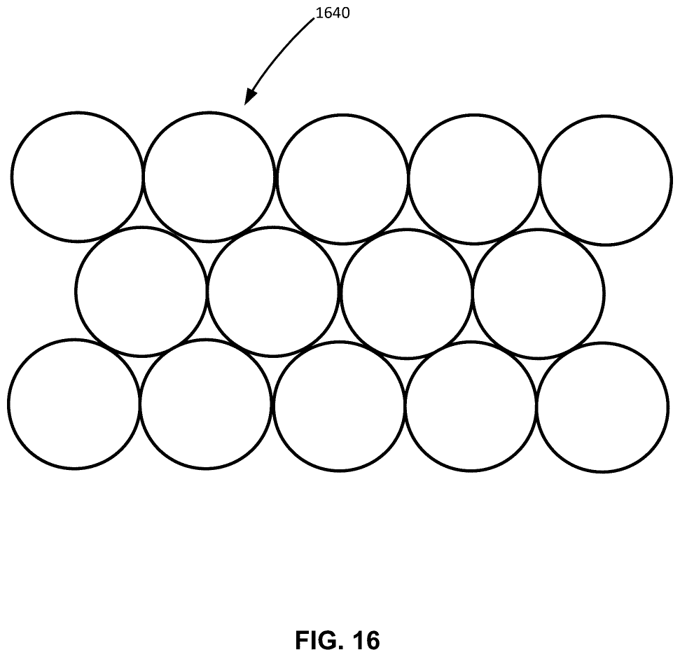

FIG. 16 provides an additional exemplary embodiment of a plurality of tubular housings 1640. In the illustrated embodiment, a plurality of tubular housings 1640 can be coupled. The coupled tubular housings 1640 can be suspended from a single parachute 312. By coupling a plurality of tubular housings 1640 for suspension by a single parachute 312, the number of releasable items 426 that can be deployed to a target deployment zone is greatly increased. It is contemplated that a plurality of housings 322 of any suitable shape for releasing releasable item(s) 426 may be coupled for suspension by a single parachute 312, helicopter, or balloon.

FIG. 17 provides an additional exemplary embodiment of a housing 1760. The housing 1760 may be semi-conical, or put another way, may be a tapered tube. In such an embodiment, the housing 1760 gradually grows in diameter from top to bottom. Housing 1760 being a tapered tube may aid in preventing releasable items from becoming lodged within housing 1760 upon release.

FIG. 18 provides an additional exemplary embodiment of a housing 1870. The housing 1870 may be a stepped-diameter tube. In such an embodiment, the housing 1870 grows in diameter from top to bottom in steps. Housing 1870 being a stepped-diameter tube may aid in preventing releasable items from becoming lodged within housing 1870 upon release.

With respect to FIG. 19, a side view of an exemplary embodiment of a housing 1870 is shown. Releasable item 1926 may be supported within housing 1870 by a support tray 1925a. Support tray 1925a may be supported within housing 1870 by releasable fastener 1924. Support tray 1925a may be similar to jettisonable support tray in structure and function but may be additionally coupled to hinge 1930. Hinge 1930 may optionally be spring loaded to enable rapid pivoting of support tray 1925a and to prevent support tray 1925a from rebounding into the release path of a releasable item. In this manner, upon release of releasable fastener 1924, support tray 1925a may rotate about hinge 1930 rather than being released from housing 1870. Support tray 1925b has partially rotated about its respective hinge along Arrow D. Support tray 1925c has fully rotated about its respective hinge along Arrow E. In this manner, releasable item 1926 may be released from housing 1870 without releasing support tray 1925a. Such an embodiment may be desirable where releasable item 1926 may be damaged by coming into contact with a jettisonable support tray during release from the housing.

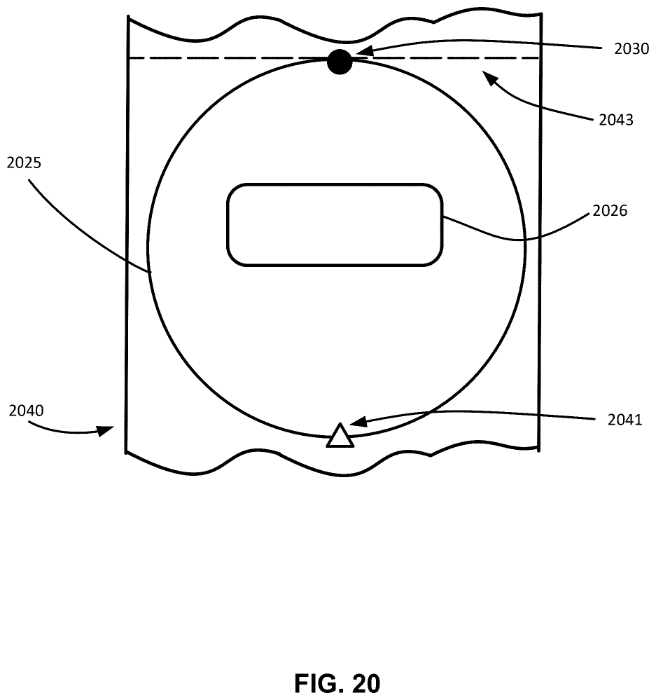

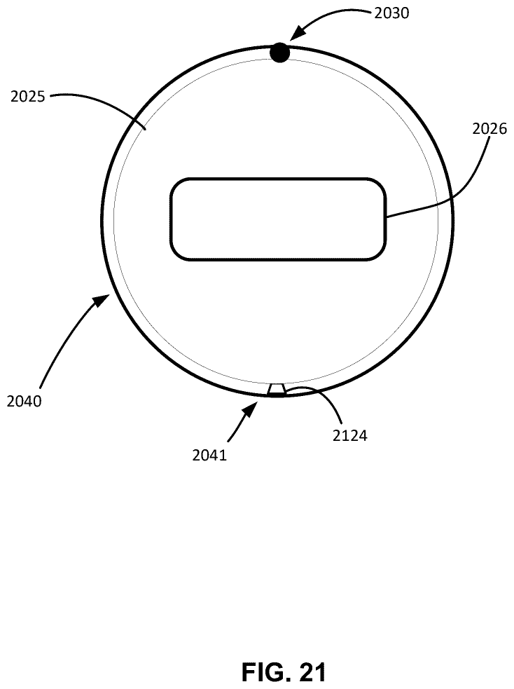

FIG. 20 provides a front view of an exemplary embodiment of a generally tubular housing 2040 having a generally circular support tray 2025. In the illustrated embodiment, support tray 2025 has been released and is substantially vertical within and with respect to the housing 2040. Releasable item 2026 has begun to exit housing 2040 under the influence of gravity. Support tray 2025, which previously was substantially horizontal along dashed line 2043, has pivoted downwardly about hinge point 2030, after being released at release point 2041 by a releasable fastener. FIG. 21 provides a top view of the exemplary embodiment provided by FIG. 20 prior to release of releasable fastener 2124 at release point 2041. Support tray 2025 has not yet pivoted about hinge point 2030 and remains substantially horizontal within and with respect to housing 2040. Releasable item 2026 remains supported within housing 2040 by support tray 2025.

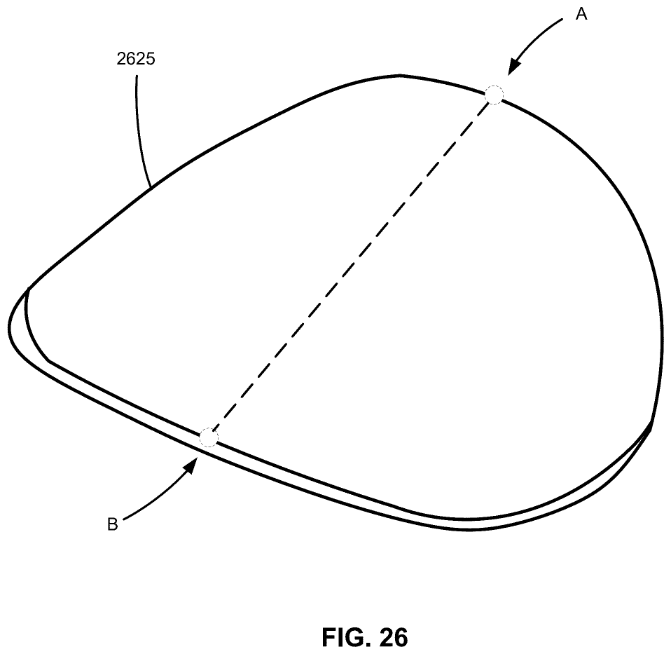

Turning ahead to FIG. 26, an exemplary embodiment of a support tray 2625 is provided. In various embodiments of a housing, a circular support tray may encounter difficulty in pivoting to release a releasable item. A support tray 2625 formed as a hyperbolic paraboloid may be used in any of the embodiments disclosed herein. A distance between two uppermost points on the support tray 2625, A and B, may be substantially equal to or less than an interior diameter of a housing. A curvature of the bottom of the support tray 2625 may be substantially equal to or less than an interior radius of a housing. In an exemplary embodiment, the support tray 2625 may be shaped substantially similarly to a Pringles® (a registered trademark of Pringles LLC of Delaware) brand potato chip. Stated more generally, in various exemplary embodiments the support tray 2625 may be configured as a hyperbolic paraboloid or similar shape.

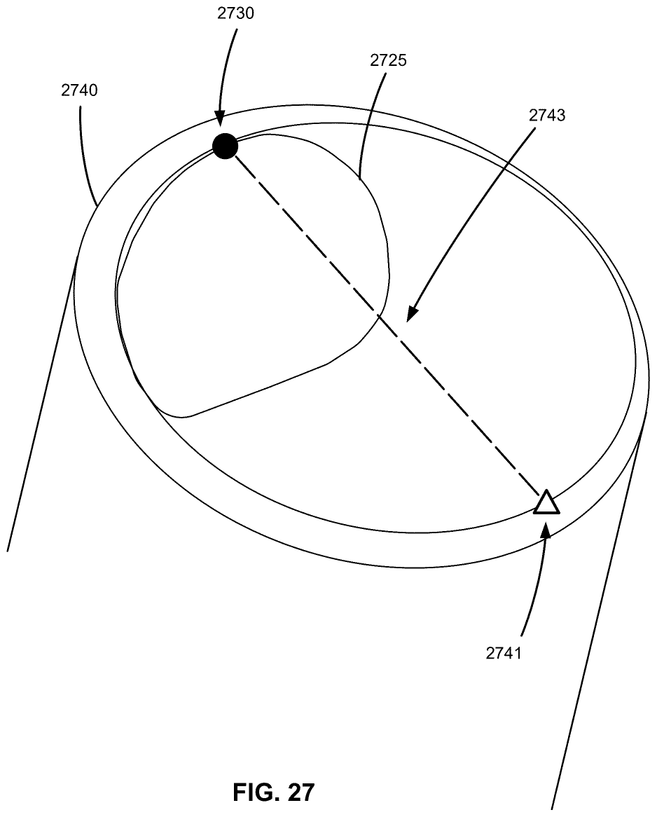

FIG. 27 provides an exemplary embodiment of a support tray 2725 formed as a hyperbolic paraboloid positioned within a generally tubular housing 2740. In the illustrated embodiment, support tray 2725 has been released and is substantially vertical within and with respect to the housing 2740. Support tray 2725, which previously was substantially horizontal along dashed line 2743, has pivoted downwardly about hinge point 2730, after being released at release point 2741 by a releasable fastener.

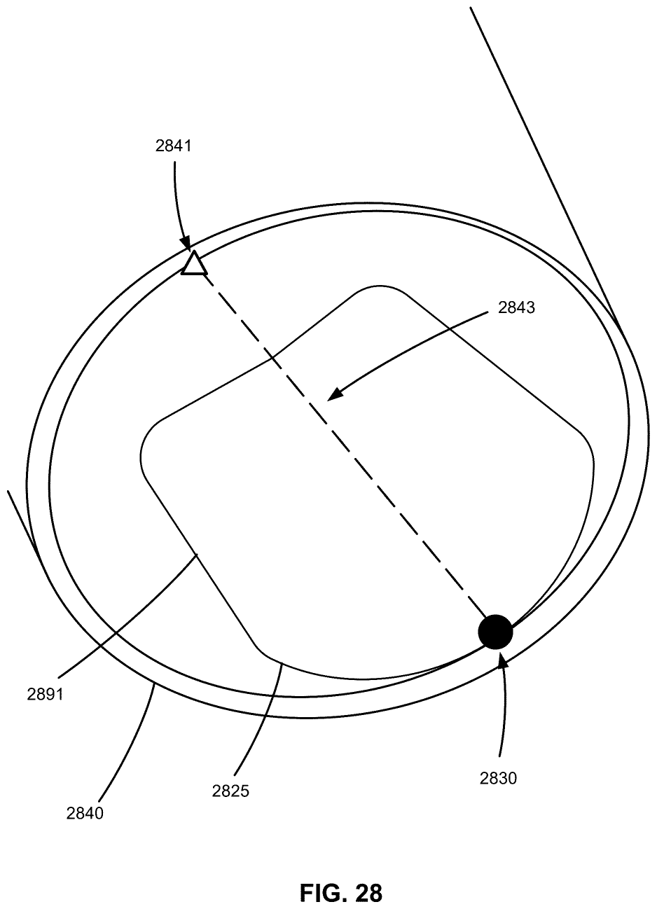

FIG. 28 provides an exemplary embodiment of a support tray 2825 positioned within a generally tubular housing 2840. Support tray 2825 may be a partial hyperbolic paraboloid. For example, an edge of a hyperbolic paraboloid may be truncated, resulting in a substantially flat edge 2891. It is understood that this is merely an exemplary embodiment, and any suitable portion of support tray 2825 may be truncated, removed, and/or cut off to form a partial hyperbolic paraboloid. A hyperbolic paraboloid shaped support tray and/or a partial hyperbolic paraboloid shaped support tray may be used with any of the embodiments described herein. In various embodiments, a distance between two uppermost points on the support tray may be substantially equal to or less than an interior diameter of a housing. A curvature of the bottom of the support tray 2625 may be substantially equal to or less than an interior radius of a housing. In the illustrated embodiment, support tray 2825 has been released and is substantially vertical within and with respect to the housing 2840. Support tray 2825, which previously was substantially horizontal along dashed line 2843, has pivoted downwardly about hinge point 2830, after being released at release point 2841 by a releasable fastener.

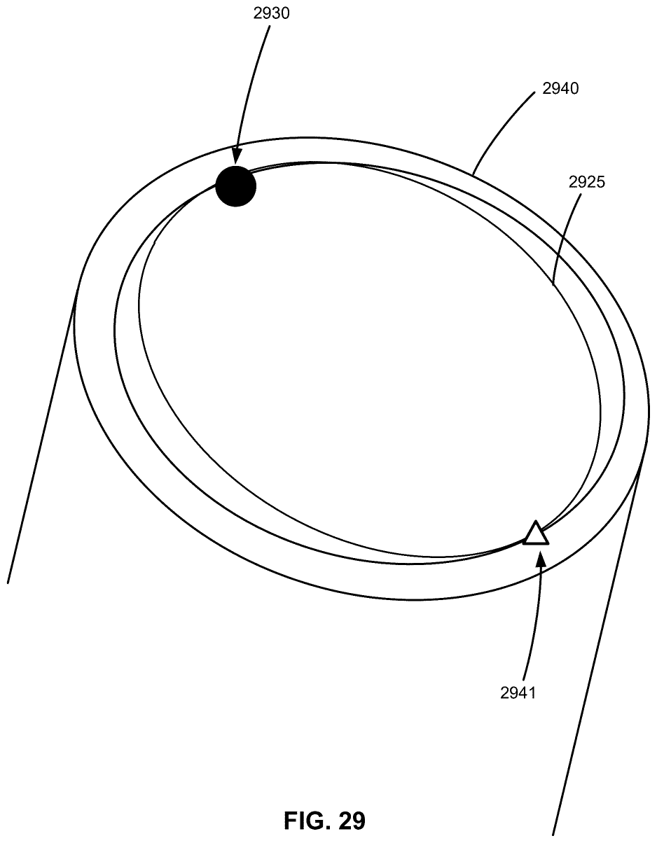

FIG. 29 provides a perspective view of the exemplary embodiment provided by FIG. 27 prior to release of releasable fastener at release point 2941. Support tray 2925 has not yet pivoted about hinge point 2930 and remains substantially horizontal within and with respect to housing 2940.

Turning now to FIG. 22, an exemplary embodiment of a plurality of munitions 2242 stored within a housing 2222 of a midair dispenser 310 is provided. As illustrated, the releasable fastener 2224 can be configured to support, directly or indirectly, a jettisonable support tray 2228 which in turn supports, directly or indirectly, a munition 2242. The releasable fastener 2224 can also be configured to extend into the body of the munition 2242 to directly support munition 2242 within the housing 2222. Such a configuration may be preferable based on the characteristics of munition 2242, for example if the nose of munition 2242 is particularly sensitive. Those of ordinary skill in the art will understand that there are many such cases where it would be preferable to support a munition 2242 by its body rather than by its nose. Depending on the chosen configuration, when the releasable fastener 2224 is positionally transformed to cease supporting either the jettisonable support tray 2228 or the munition 2242, the munition 2242 can then exit the housing 2222 through opening 2227 under the influence of gravity.

According to various embodiments, a user can deploy a midair dispenser 310 from an aircraft or other suitable method for deploying a midair dispenser 310 at an elevated position. The midair dispenser 310 can be suspended at the elevated position by a parachute 312, helicopter, balloon, or the like. A releasable fastener 424 can be disposed at least partially within the midair dispenser 310. The releasable fastener 424 can be positionally transformed with respect to the midair dispenser by a motor 629. A releasable item 426 can be released from the midair dispenser due to the positional transformation of releasable fastener 424. For example, the releasable item 426 can be supported within the midair dispenser 310 by the releasable fastener 424, and upon activation of the releasable fastener 424 the releasable item 426 can separate from the midair dispenser 310 under the influence of gravity. The midair dispenser can comprise one housing 422 or a plurality of housings 422. The housing(s) 422 can be any suitable shape for storing and deploying releasable item(s) 426, for example the housing(s) 422 can be tubular.

According to various embodiments, a midair dispenser 310 can include a plurality of housings 622, with each housing 622 including at least one releasable fastener 624a. The releasable fastener 624a can be disposed at least partially within its respective housing 622 and can be configured to be positionally transformed with respect to housing 622. Each housing 622 can also store at least one releasable item 626a. The releasable item 626a can be disposed such that the releasable item 626a is released from the housing 622 upon the positional transformation of releasable fastener 624a. Additionally, each housing 622 can include at least a second releasable fastener 624b. The releasable fastener 624b can be disposed at least partially within the housing 622. Releasable fastener 624a can be disposed such that it is between releasable fastener 624b and an opening 627 of the housing.

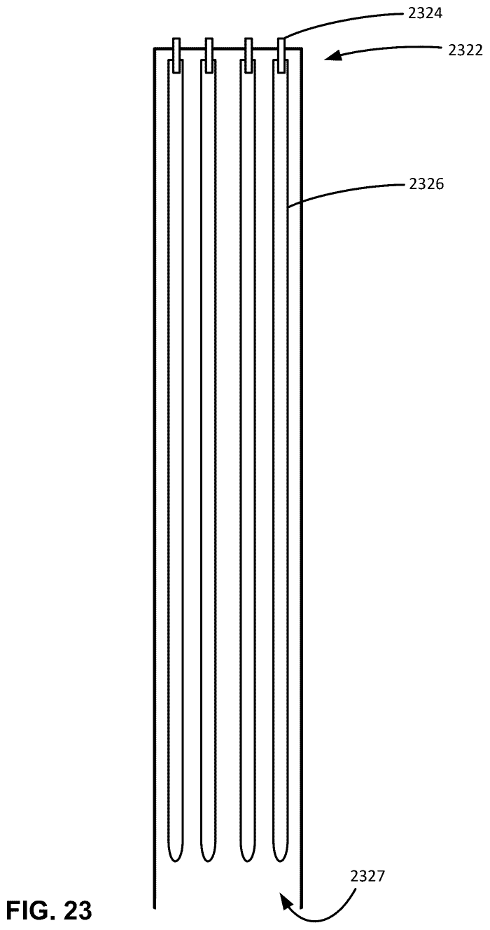

With respect to FIG. 23, it may be desirable to release a number of releasable items 2326 having a height greater than for example 50% of the housing 2322 height but a width or circumference permitting additional releasable items 2326 to be stored within housing 2322. The height of releasable item 2326 can also be for example greater than 10% of the height of housing 2322, greater than 20% of the height of housing 2322, greater than 30% of the height of housing 2322, or greater than 40% of the height of housing 2322. In such cases, releasable fastener 2324 can be disposed at least partially within the top face of housing 2322 with releasable item 2326 disposed below releasable fastener 2324 and supported within housing 2322 by releasable fastener 2324. In response to release of releasable fastener 2324, releasable item 2326 can exit the housing 2322 through opening 2327.

In various embodiments, it may be desirable for a user to recover midair dispenser 310 for reuse. In such applications, midair dispenser 310 and its respective housings 322 can be designed using materials with sufficient strength to withstand impact with the ground after deployment from an aircraft without suffering damage. For example, midair dispenser 310 can be constructed using steel. Midair dispenser 310 may also be constructed using any rigid material, including aluminum, composites, plastic, and wood, among others. In various embodiments, midair dispenser 310 may be constructed out of multiple materials. For example, in one exemplary embodiment various aspects of midair dispenser 310 were constructed using steel, lumber, plastic, and plywood. When midair dispenser 310 is recovered, an additional releasable item 426 can be stored within midair dispenser 310 and releasable fastener 424 can be reset to a position configured to support the additional releasable item 426 within the housing 322. In alternative embodiments, the user may not desire to recover midair dispenser 310 or it may not be possible to recover midair dispenser 310. In such applications, midair dispenser 310 can be designed using materials with sufficient strength to withstand the forces associated with deployment from an aircraft.

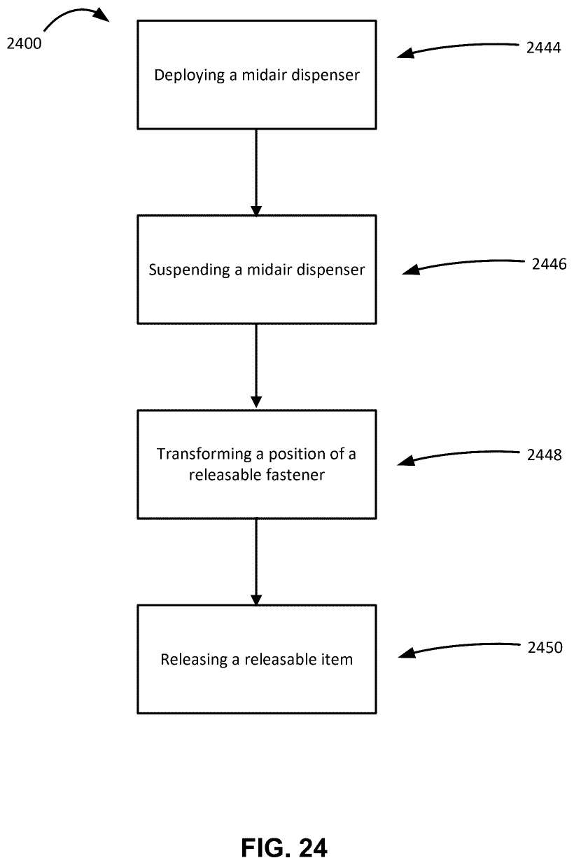

With respect to FIG. 24, a method 2400 for releasing an item midair is illustrated. The method 2400 can include deploying a midair dispenser from an aircraft (step 2444), suspending a midair dispenser by a parachute (step 2446), transforming a position of a releasable fastener with respect to the midair dispenser (step 2448), and releasing a releasable item by the releasable fastener (step 2450).

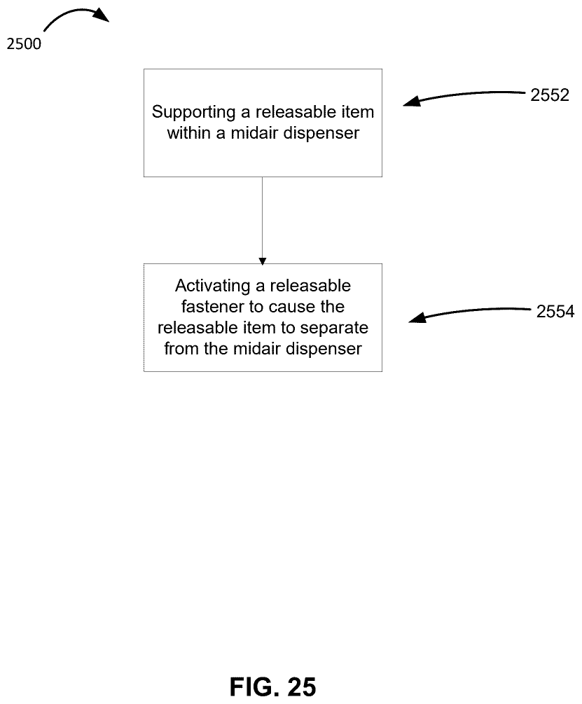

With respect to FIG. 25, a method 2500 for using a midair dispenser is illustrated. The method 2500 can include supporting, by a releasable fastener, a releasable item within a midair dispenser (step 2552), and activating the releasable fastener to cause the releasable item to separate from the midair dispenser under the influence of gravity (step 2554).

In various embodiments, alternative methods of extracting releasable item 426 from midair dispenser 310 may be utilized. For example, releasable item 426 may be separated from midair dispenser 310 by a spring, compressed air, tension bars, or any other suitable mechanical, electrical, magnetic or pneumatic components for separating releasable item 426 from midair dispenser 310.

According to an exemplary embodiment, a midair dispenser was tested. The height and width of the exemplary midair dispenser were approximately 4 feet while the length of the exemplary midair dispenser was approximately 6 feet. The exemplary midair dispenser was launched from an airplane. About 40 releasable items of about 5-10 pounds each were released from the exemplary midair dispenser. A number of releasable items were released sequentially while a number of other releasable items were released simultaneously to demonstrate the versatility in release timing offered by the embodiments disclosed herein. The exemplary midair dispenser was recovered and relaunched to illustrate the durability and reusability of the embodiments disclosed herein.

In various exemplary embodiments, method of using a midair dispenser comprises supporting, by a releasable fastener, a releasable item within the midair dispenser; and activating the releasable fastener to cause the releasable item to separate from the midair dispenser under the influence of gravity.

In various exemplary embodiments, a midair dispenser comprises a plurality of housings, each housing comprising: a first releasable fastener disposed at least partially within the housing; and a first releasable item disposed such that the first releasable item is released from the housing upon a release of the first releasable fastener. Each of the plurality of housings may further comprise a second releasable fastener disposed at least partially within the housing, the first releasable fastener disposed between the second releasable fastener and an opening of the housing.

It will be appreciated that in accordance with principles of the present disclosure, a midair dispenser may be carried aloft via any suitable means, such as by a fixed-wing aircraft, a helicopter or other rotary-wing aircraft, a balloon, a kite, a rocket or missile, or the like. Moreover, a midair dispenser may subsequently be decoupled from or deployed by the lofting means, such as by extraction from a rear cargo door of an aircraft, separation from a suspending cable beneath a helicopter, release from a hardpoint beneath the wing of an airplane, and/or the like. Yet further, a midair dispenser may be suspended in an airstream via any suitable means, for example by a kite, a balloon, a parachute, a helicopter or other rotary wing aircraft, or the like. Suitable combinations of the above, such as lofting via cargo aircraft, deployment via cargo door, and suspension via parachute, will be understood by those of skill in the art. Similarly, unsuitable or nonsensical combinations of the above (such as lofting via balloon followed by suspension by helicopter) will likewise be apparent to those of skill in the art.

Principles of the present disclosure may be compatible with and/or utilize certain components or techniques disclosed in other U.S. Patents and/or U.S. Patent applications, including but not limited to: (i) U.S. Pat. No. 9,789,968 to Fox entitled “RING RELEASE SYSTEMS AND METHODS”; (ii) U.S. Pat. No. 9,452,842 to Fox entitled “PARACHUTE CANOPY INSERT”; (iii) U.S. Pat. No. 9,399,514 to Fox entitled “AERIAL DELIVERY SYSTEM WITH MUNITION ADAPTER AND LATCHING RELEASE”; (iv) U.S. Pat. No. 8,864,080 to Fox entitled “EXPENDABLE AERIAL DELIVERY SYSTEM”; (v) U.S. Pat. No. 8,851,426 to Fox entitled “ENHANCED CRUCIFORM PARACHUTE”; (vi) U.S. Pat. No. 8,313,063 to Fox entitled “PARACHUTE RELEASE SYSTEM AND METHOD”; (vii) U.S. Pat. No. 8,210,479 to Fox entitled “PARACHUTE INLET CONTROL SYSTEM AND METHOD”; (viii) U.S. Pat. No. 8,096,509 to Fox entitled “PARACHUTE INLET CONTROL SYSTEM AND METHOD”; (ix) U.S. Patent No. 8,083,184 to Fox entitled “AERIAL DELIVERY SYSTEM”; (x) U.S. Pat. No. 7,967,254 to Fox entitled “SLING RELEASE MECHANISM”; (xi) U.S. Pat. No. 7,264,205 to Fox entitled “PARACHUTE RELEASE APPARATUS”; (xii) U.S. Pat. No. 7,261,258 to Fox entitled “CRUCIFORM PARACHUTE DESIGN”; (xiii) U.S. Pat. No. 6,994,295 to Fox entitled “QUONSET TYPE PARACHUTE”; (xiv) U.S. Pat. No. 6,843,451 to Fox entitled “PARACHUTE SLIDER REEFING WITH FRICTION INDUCED RETARDATION”; (xv) U.S. Pat. No. 6,290,177 to Fox entitled “BI-DIRECTIONAL PILOT PARACHUTE RELEASE ASSEMBLY”; and (xvi) U.S. Pat. No. 10,689,123 to Fox entitled “PARACHUTE INLET CONTROL SYSTEM AND METHOD.” Each of the foregoing are hereby incorporated by reference in their entireties for all purposes (but except for any subject matter disclaimers or disavowals, and except to the extent that the incorporated material is inconsistent with the express disclosure herein, in which case the language in this disclosure shall control).

While the principles of this disclosure have been shown in various embodiments, many modifications of structure, arrangements, proportions, the elements, materials and components, used in practice, which are particularly adapted for a specific environment and operating requirements may be used without departing from the principles and scope of this disclosure. These and other changes or modifications are intended to be included within the scope of the present disclosure and may be expressed in the following claims.

In the foregoing specification, various embodiments have been described. However, one of ordinary skill in the art appreciates that various modifications and changes can be made without departing from the scope of the present disclosure as set forth in the claims below. Accordingly, the specification is to be regarded in an illustrative rather than a restrictive sense, and all such modifications are intended to be included within the scope of the present disclosure. Likewise, benefits, other advantages, and solutions to problems have been described above with regard to various embodiments. However, benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. Also, as used herein, the terms “coupled,” “coupling,” or any other variation thereof, are intended to cover a physical connection, an electrical connection, a magnetic connection, an optical connection, a communicative connection, a functional connection, and/or any other connection. When language similar to “at least one of A, B, or C” or “at least one of A, B, and C” is used in the claims, the phrase is intended to mean any of the following: (1) at least one of A; (2) at least one of B; (3) at least one of C; (4) at least one of A and at least one of B; (5) at least one of B and at least one of C; (6) at least one of A and at least one of C; or (7) at least one of A, at least one of B, and at least one of C.

What is claimed is:

1. A midair dispenser comprising:
a housing;
a releasable fastener disposed at least partially within the housing; and
a releasable item disposed such that the releasable item is released from the housing upon a release of the releasable fastener.

2. The midair dispenser of claim 1, further comprising a jettisonable support tray, wherein the jettisonable support tray is disposed between the releasable item and the releasable fastener.

3. The midair dispenser of claim 2, wherein the releasable item is at least one of a drone or a munition.

4. The midair dispenser of claim 3, wherein the munition is a kinetic munition comprising a plurality of retractable fins.

5. The midair dispenser of claim 4, wherein the releasable fastener is disposed at least partially within the munition prior to the release of the releasable fastener.

6. The midair dispenser of claim 1, wherein the releasable fastener is an electromagnet.

7. The midair dispenser of claim 1, wherein the release of the releasable fastener is triggered by at least one of a specified air pressure or a timer.

8. The midair dispenser of claim 1, wherein the release of the releasable fastener is triggered by a motor.

9. The midair dispenser of claim 1, wherein the releasable item is configured to provide a signal indicating it is ready for deployment.

10. The midair dispenser of claim 9, wherein the release of the releasable fastener is triggered by the signal.

11. The midair dispenser of claim 1, further comprising at least ten releasable items.

12. The midair dispenser of claim 2, wherein the jettisonable support tray comprises a hyperbolic paraboloid.

13. A midair dispenser comprising:
a housing;
a first releasable fastener disposed at least partially within the housing;
a second releasable fastener disposed at least partially within the housing, the first releasable fastener disposed between the second releasable fastener and an opening of the housing; and
a motor mounted to the housing, the motor configured to sequentially release the first releasable fastener and the second releasable fastener to release a first releasable item and a second releasable item from the midair dispenser.

14. The midair dispenser of claim 13, wherein the first releasable item and the second releasable item are different.

15. The midair dispenser of claim 14, wherein the first releasable item comprises a drone and the second releasable item comprises a munition.

16. The midair dispenser of claim 13, wherein the first releasable fastener and the second releasable fastener are mechanically coupled such that release of the first releasable fastener causes release of the second releasable fastener.

17. The midair dispenser of claim 16, wherein release of the second releasable fastener is configured to occur following a programmable time delay after release of the first releasable fastener.

18. A method of releasing an item midair, the method comprising:
lofting a midair dispenser into the air, wherein the midair dispenser comprises a plurality of tubular housings;
suspending, by at least one of a kite, a parachute, a helicopter, or a balloon, the midair dispenser in the air;
releasing, by a motor, a releasable fastener disposed at least partially within the midair dispenser; and
releasing, by the releasable fastener, a releasable item from the midair dispenser into the air.

19. The method of claim 18, wherein the lofting the midair dispenser into the air comprises:
carrying, by an aircraft, the midair dispenser into air; and
deploying the midair dispenser from the aircraft.

20. The method of claim 18, wherein the aircraft comprises at least one of an airplane, a helicopter, a quadcopter, or a cruise missile.
